(19) United States
(12) Patent Application Publication
(10) Pub. No.: US 2010/0086150 A1
(43) Pub. Date: Apr. 8, 2010

(54) Flexible thermoacoustic device

(75) Inventors: Kai-Li Jiang, Beijing (CN); Chen Feng, Beijing (CN); Lin Xiao, Beijing (CN); Zhuo Chen, Beijing (CN); Liang Liu, Beijing (CN); Shou-Shan Fan, Beijing (CN); Qun-Qing Li, Beijing (CN); Li Qian, Beijing (CN)

Correspondence Address: PCE INDUSTRY, INC.;ATT. Steven Reiss, 288 SOUTH MAYO AVENUE, CITY OF INDUSTRY, CA, 91789, US

(73) Assignees: Tsinghua University, Beijing City (CN); HON HAI Precision Industry CO., LTD., Tu-Cheng City (TW)

(21) Appl. No.: 12/583,388

(22) Filed: Aug. 20, 2009

(30) Foreign Application Priority Data
Oct. 8, 2008 (CN) 200810216492.2

(51) Int. Cl. H04R 25/00

(52) U.S. Cl. 381/164

(57) ABSTRACT

A flexible thermoacoustic device includes a soft supporter and a sound wave generator. The sound wave generator is located on a surface of the softer supporter. The sound wave generator includes a carbon nanotube structure. The carbon nanotube structure includes a plurality of carbon nanotubes combined by van der Waals attractive force.

### BACKGROUND

1. Technical Field

The present disclosure relates to acoustic devices, particularly, to a carbon nanotube based flexible thermoacoustic device.

2. Description of Related Art

Acoustic devices generally include a signal device and a sound wave generator electrically connected to the signal apparatus. The signal device inputs signals to the sound wave generator, such as loudspeakers. A loudspeaker is an electro-acoustic transducer that converts electrical signals into sound.

There are different types of loudspeakers that can be categorized according to their working principle, such as electro-dynamic loudspeakers, electromagnetic loudspeakers, electrostatic loudspeakers, and piezoelectric loudspeakers. However, these various types of loudspeakers ultimately use mechanical vibration to produce sound waves. In other words they all achieve “electro-mechanical-acoustic” conversion. Among the various types, the electro-dynamic loudspeakers are the most widely used.

Referring to FIG. 10, an electro-dynamic loudspeaker 100, according to the prior art, typically includes a voice coil 102, a magnet 104 and a cone 106. The voice coil 102 is an electrical conductor, and is located in the magnetic field of the magnet 104. By applying an electrical current to the voice coil 102, a mechanical vibration of the cone 106 is produced caused by the interaction between the electromagnetic field produced by the voice coil 102 and the magnetic field of the magnets 104, thereby producing sound waves by kinetically pushing the air. However, the structure of the electric-powered loudspeaker 100 depends on magnetic fields and often has weighty magnets.

Thermoacoustic effect is a conversion between heat and acoustic signals. The thermoacoustic effect is distinct from the mechanism of the conventional loudspeaker, in which the pressure waves of the loudspeaker are created by the mechanical movement of the diaphragm. When signals are inputted into a thermoacoustic element, heating is produced in the thermoacoustic element according to the variations of the signal and/or signal strength. Heat is propagated into the surrounding medium. The heating of the medium causes thermal expansion and produces pressure waves in the surrounding medium, resulting in sound wave generation. Such an acoustic effect induced by temperature waves is commonly called “the thermoacoustic effect.”

A thermophone based on the thermoacoustic effect was made by H. D. Arnold and I. B. Crandall (H. D. Arnold and I. B. Crandall, “The thermophone as a precision source of sound,” Phys. Rev. 10, pp 22-38 (1917)). A platinum strip with a thickness of 7×10⁻⁵ cm as a thermoacoustic element. The heat capacity per unit area of the platinum strip is 2×10⁻⁴ J/cm²·K. However, the thermophone adopting the platinum strip, when listened to in open air, sounds extremely weak because the heat capacity per unit area of the platinum strip is too high. Furthermore, the thermophone can not be folded into other shapes and the application very limited because the platinum strip has no flexibility.

What is needed, therefore, is to provide a flexible soft effective thermoacoustic device able of being moved without being destroyed and have a good sound effect.

### BRIEF DESCRIPTION OF THE DRAWINGS

Many aspects of the present flexible thermoacoustic device can be better understood with reference to the following drawings. The components in the drawings are not necessarily to scale, the emphasis instead being placed upon clearly illustrating the principles of the present disclosure. Moreover, in the drawings, like reference numerals designate corresponding parts throughout the several views.

FIG. 1 is a schematic view of a flexible thermoacoustic device in accordance with one embodiment.

FIG. 2 shows a Scanning Electron Microscope (SEM) image of an aligned carbon nanotube film used in the flexible thermoacoustic device of FIG. 1.

FIG. 3 is a schematic view of a carbon nanotube segment of the aligned carbon nanotube film of FIG. 2.

FIG. 4 shows an SEM image of another carbon nanotube film with carbon nanotubes entangled with each other therein.

FIG. 5 shows an SEM image of an untwisted carbon nanotube wire.

FIG. 6 shows an SEM image of a twisted carbon nanotube wire.

FIG. 7 shows schematic of a textile formed by a plurality of carbon nanotube wires and/or films.

FIG. 8 is a frequency response curve of the flexible thermoacoustic device of FIG. 1.

FIG. 9 is a schematic view of a thermoacoustic flag in accordance with another embodiment.

FIG. 10 is a schematic view of a conventional loudspeaker.

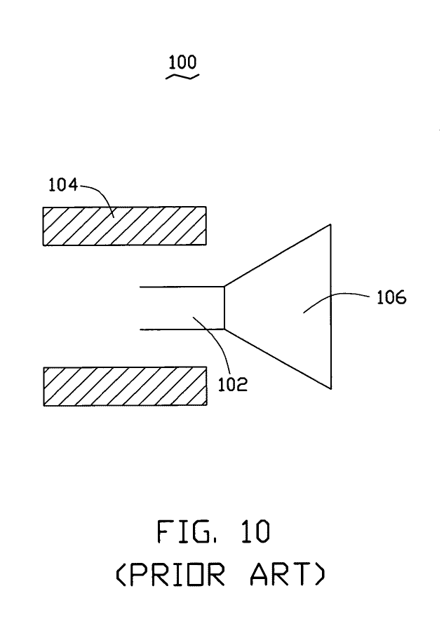

Corresponding reference characters indicate corresponding parts throughout the several views. The exemplifications set out herein illustrate at least one embodiment of the present flexible thermoacoustic device, and such exemplifications are not to be construed as limiting the scope of the present disclosure in any manner.

### DETAILED DESCRIPTION OF EXEMPLARY EMBODIMENTS

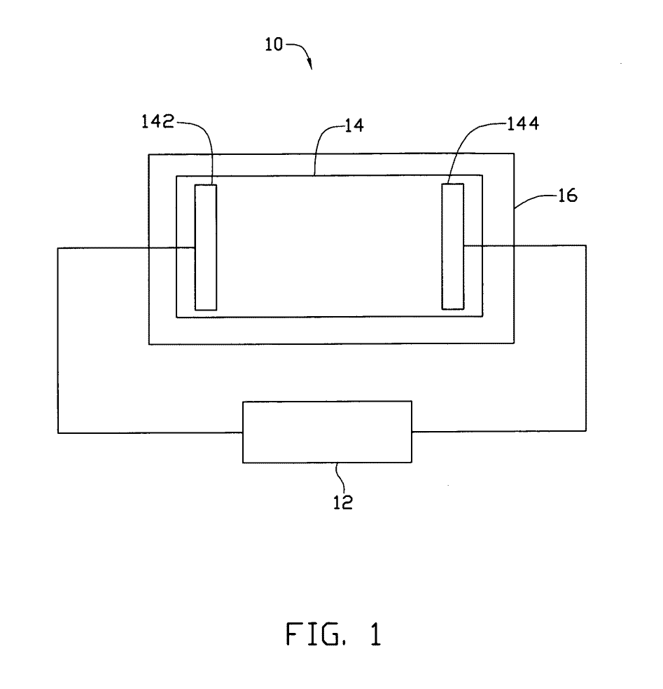

Referring to FIG. 1, one embodiment of a flexible thermoacoustic device 10 includes a signal generator 12, a sound wave generator 14, a first electrode 142, a second electrode 144, and a soft supporter 16. The sound wave generator 14 is disposed on a surface of the soft supporter 16. The first electrode 142 and the second electrode 144 are located apart from each other, and are electrically connected to the sound wave generator 14. In addition, the first electrode 142 and the second electrode 144 are electrically connected to the signal device 12.

The supporter 16 is configured to support the sound wave generator 14. There is no particular restriction on the shape of the supporter 16 and it may be appropriately selected depending on the purpose, for example, the shape of the sound wave generator 14. The supporter 16 can have a planar and/or a curved surface. The supporter 16 can also have a surface where the sound wave generator 14 is securely located, exposed, or hidden. The material of the supporter 16 should be soft/flexible and insulative, such as plastic, resin, fabric, paper, and rubber. The supporter 16 can have a good thermal insulating property to prevent the supporter 16 from absorbing heat generated by the sound wave generator 14. In addition, the supporter 16 can have a relatively rough surface, whereby the sound wave generator 14 can have an increased contact area with the surrounding medium.

An adhesive layer (not shown) can be further provided between the sound wave generator 14 and the supporter 16. The adhesive layer can be located on the surface of the sound wave generator 14. The adhesive layer can provide a stronger bond between the sound wave generator 14 and the supporter 16 if needed. In one embodiment, the adhesive layer is conductive and a layer of silver paste is used. A thermally insulative adhesive can also be selected to form the adhesive layer.

The sound wave generator 14 includes a carbon nanotube structure. The carbon nanotube structure can be many different structures and have a large specific surface area. The heat capacity per unit area of the carbon nanotube structure can be less than 2×10⁻⁴ J/cm²·K. In one embodiment, the heat capacity per unit area of the carbon nanotube structure is less than or equal to about 1.7×10⁻⁶ J/cm²·K. The carbon nanotube structure can include a plurality of carbon nanotubes uniformly distributed therein, and the carbon nanotubes therein can be combined by van der Waals attractive force therebetween. It is understood that the carbon nanotube structure must include metallic carbon nanotubes. The carbon nanotubes in the carbon nanotube structure can be orderly or disorderly arranged. The term ‘disordered carbon nanotube structure’ includes a structure where the carbon nanotubes are arranged along many different directions, such that the number of carbon nanotubes arranged along different directions can be almost the same (e.g. uniformly disordered); and/or entangled with each other. ‘Ordered carbon nanotube structure’ includes a structure where the carbon nanotubes are arranged in a consistently systematic manner, e.g., the carbon nanotubes are arranged approximately along a same direction and or have two or more sections within each of which the carbon nanotubes are arranged approximately along a same direction (different sections can have different directions). The carbon nanotubes in the carbon nanotube structure can be selected from single-walled, double-walled, and/or multi-walled carbon nanotubes. It is also understood that there may be many layers of ordered and/or disordered carbon nanotube films in the carbon nanotube structure.

The carbon nanotube structure may have a substantially planar structure. The thickness of the carbon nanotube structure may range from about 0.5 nanometers to about 1 millimeter. The smaller the specific surface area of the carbon nanotube structure, the greater the heat capacity will be per unit area. The larger the heat capacity per unit area, the smaller the sound pressure level of the thermoacoustic device.

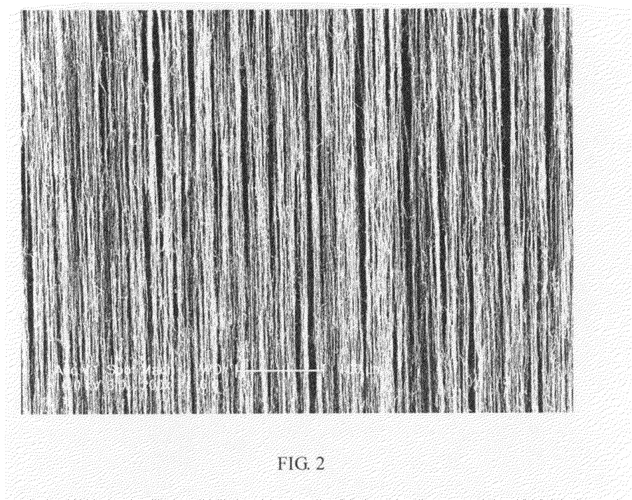

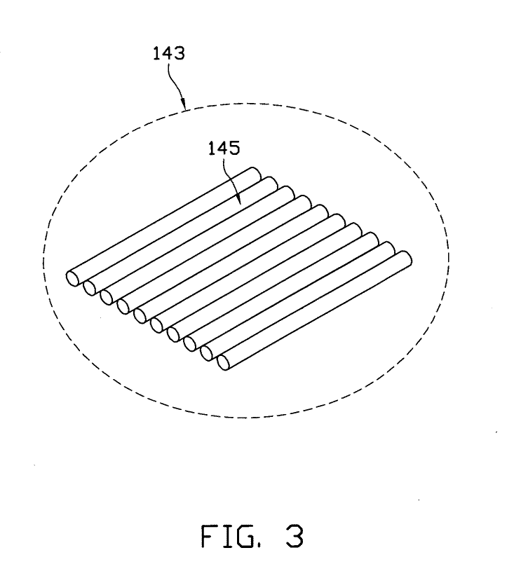

In one embodiment, the carbon nanotube structure can include at least one drawn carbon nanotube film. Examples of a drawn carbon nanotube film is taught by U.S. Pat. No. 7,045,108 to Jiang et al., and WO 2007015710 to Zhang et al. The drawn carbon nanotube film includes a plurality of successive and oriented carbon nanotubes joined end-to-end by van der Waals attractive force therebetween. The carbon nanotubes in the carbon nanotube film can be substantially aligned in a single direction. The drawn carbon nanotube film can be formed by drawing a film from a carbon nanotube array that is capable of having a film drawn therefrom. Referring to FIGS. 2 to 3, each drawn carbon nanotube film includes a plurality of successively oriented carbon nanotube segments 143 joined end-to-end by van der Waals attractive force therebetween. Each carbon nanotube segment 143 includes a plurality of carbon nanotubes 145 substantially parallel to each other, and combined by van der Waals attractive force therebetween. As can be seen in FIG. 2, some variations can occur in the drawn carbon nanotube film. The carbon nanotubes 145 in the drawn carbon nanotube film are also oriented along a preferred orientation. The carbon nanotube film can also be treated with an organic solvent to increase the mechanical strength and toughness of the treated carbon nanotube film and reduce the coefficient of friction of the treated carbon nanotube films. The treated carbon nanotube film has a larger heat capacity per unit area and thus produces less of a thermoacoustic effect than the same film before treatment. A thickness of the carbon nanotube film can range from about 0.5 nanometers to about 100 micrometers.

The carbon nanotube structure of the sound wave generator 14 can also include at least two stacked carbon nanotube films. In other embodiments, the carbon nanotube structure can include two or more coplanar carbon nanotube films. These coplanar carbon nanotube films can also be stacked one upon other films. Additionally, an angle can exist between the orientation of carbon nanotubes in adjacent films, stacked and/or coplanar. Adjacent carbon nanotube films can be combined only by the van der Waals attractive force therebetween. The number of the layers of the carbon nanotube films is not limited. However, a large enough specific surface area must be maintained to achieve the thermoacoustic effect. An angle between the aligned directions of the carbon nanotubes in the two adjacent carbon nanotube films can range from 0 degrees to about 90 degrees. When the angle between the aligned directions of the carbon nanotubes in adjacent carbon nanotube films is larger than 0 degrees, a microporous structure is defined by the carbon nanotubes in the sound wave generator 14. The carbon nanotube structure in an embodiment employing these films will have a plurality of micropores. Stacking the carbon nanotube films will add to the structural integrity of the carbon nanotube structure. In some embodiments, the carbon nanotube structure has a free standing structure and does not require the use of structural support.

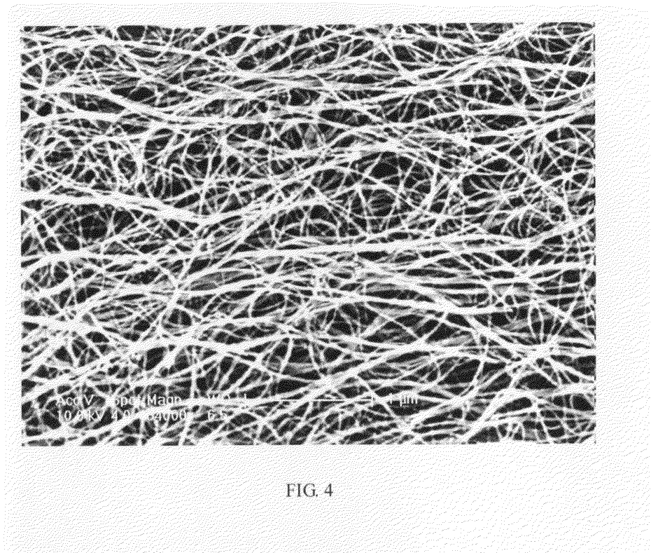

In other embodiments, the carbon nanotube structure includes a flocculated carbon nanotube film. Referring to FIG. 4, the flocculated carbon nanotube film can include a plurality of long, curved, disordered carbon nanotubes entangled with each other. A length of the carbon nanotubes can be above 10 centimeters. Further, the flocculated carbon nanotube film can be isotropic. The carbon nanotubes can be substantially uniformly dispersed in the carbon nanotube film. The adjacent carbon nanotubes are acted upon by the van der Waals attractive force therebetween, thereby forming an entangled structure with micropores defined therein. It is understood that the flocculated carbon nanotube film is very porous. Sizes of the micropores can be less than 10 micrometers. The porous nature of the flocculated carbon nanotube film will increase the specific surface area of the carbon nanotube structure. Further, due to the carbon nanotubes in the carbon nanotube structure being entangled with each other, the carbon nanotube structure employing the flocculated carbon nanotube film has excellent durability, and can be fashioned into desired shapes with a low risk to the integrity of carbon nanotube structure. Thus, the sound wave generator 14 may be formed into many shapes. The flocculated carbon nanotube film, in some embodiments, will not require the use of structural support due to the carbon nanotubes being entangled and adhered together by van der Waals attractive force therebetween. The thickness of the flocculated carbon nanotube film can range from about 0.5 nanometers to about 1 millimeter. It is also understood that many of the embodiments of the carbon nanotube structure are flexible and/or do not require the use of structural support to maintain their structural integrity.

Furthermore, the carbon nanotube film and/or the entire carbon nanotube structure can be treated, such as by laser, to improve the light transmittance of the carbon nanotube film or the carbon nanotube structure. For example, the light transmittance of the untreated drawn carbon nanotube film ranges from about 70%-80%, and after laser treatment, the visible light transmittance of the untreated drawn carbon nanotube film can be improved to about 95%. The heat capacity per unit area of the carbon nanotube film and/or the carbon nanotube structure will increase after the laser treatment.

In other embodiments, the carbon nanotube structure includes one or more carbon nanotube wire structures. The carbon nanotube wire structure includes at least one carbon nanotube wire. A heat capacity per unit area of the carbon nanotube wire structure can be less than 2×10⁻⁴ J/cm²·K. In one embodiment, the heat capacity per unit area of the carbon nanotube wire-like structure is less than 5×10⁻⁵ J/cm²·K. The carbon nanotube wire can be twisted or untwisted. The carbon nanotube wire structure includes carbon nanotube cables that comprise of twisted carbon nanotube wires, untwisted carbon nanotube wires, or combinations thereof The carbon nanotube cable comprises of two or more carbon nanotube wires, twisted or untwisted, that are twisted or bundled together. The carbon nanotube wires in the carbon nanotube wire structure can be substantially parallel to each other to form a bundle-like structure or twisted with each other to form a twisted structure.

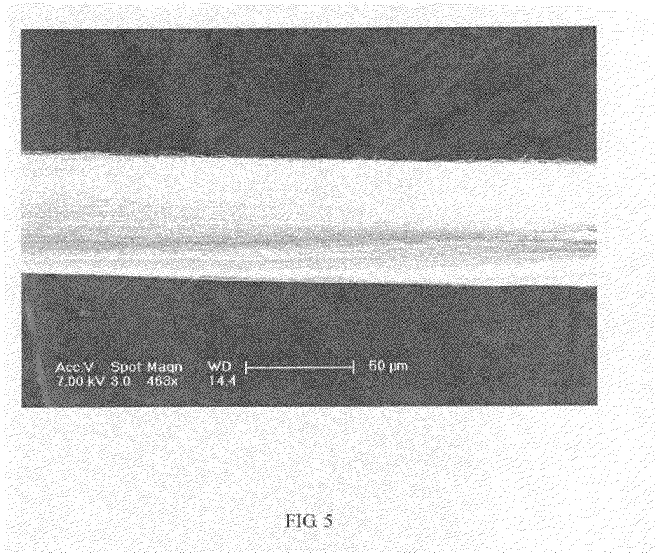

The untwisted carbon nanotube wire can be formed by treating the drawn carbon nanotube film with an organic solvent. Specifically, the drawn carbon nanotube film is treated by applying the organic solvent to the drawn carbon nanotube film to soak the entire surface of the drawn carbon nanotube film. After being soaked by the organic solvent, the adjacent paralleled carbon nanotubes in the drawn carbon nanotube film will bundle together, due to the surface tension of the organic solvent when the organic solvent volatilizes, and thus, the drawn carbon nanotube film will be shrunk into untwisted carbon nanotube wire. The organic solvent is volatile. Referring to FIG. 5, the untwisted carbon nanotube wire includes a plurality of carbon nanotubes substantially oriented along a same direction (e.g., a direction along the length of the untwisted carbon nanotube wire). The carbon nanotubes are substantially parallel to the axis of the untwisted carbon nanotube wire. Length of the untwisted carbon nanotube wire can be set as desired. The diameter of an untwisted carbon nanotube wire can range from about 0.5 nanometers to about 100 micrometers. In one embodiment, the diameter of the untwisted carbon nanotube wire is about 50 micrometers. Examples of the untwisted carbon nanotube wire is taught by US Patent Application Publication US 2007/0166223 to Jiang et al.

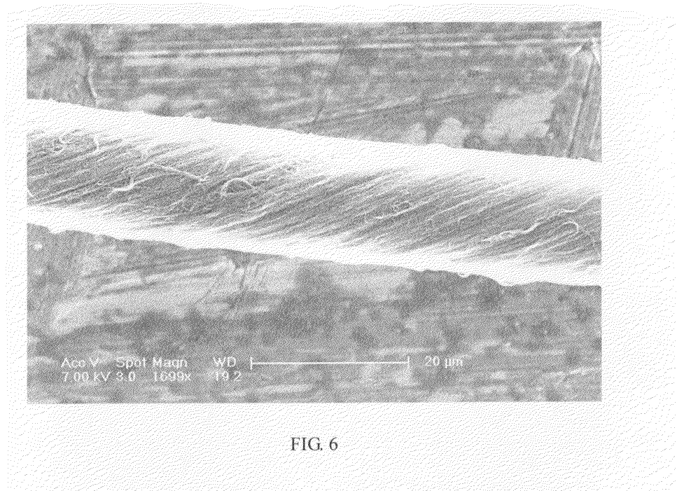

The twisted carbon nanotube wire can be formed by twisting a drawn carbon nanotube film by using a mechanical force to turn the two ends of the drawn carbon nanotube film in opposite directions. Referring to FIG. 6, the twisted carbon nanotube wire includes a plurality of carbon nanotubes oriented around an axial direction of the twisted carbon nanotube wire. The carbon nanotubes are aligned around the axis of the carbon nanotube twisted wire like a helix. Length of the carbon nanotube wire can be set as desired. The diameter of the twisted carbon nanotube wire can range from about 0.5 nanometers to about 100 micrometers. Further, the twisted carbon nanotube wire can be treated with a volatile organic solvent, before or after being twisted. After being soaked by the organic solvent, the adjacent paralleled carbon nanotubes in the twisted carbon nanotube wire will bundle together, due to the surface tension of the organic solvent when the organic solvent volatilizing. The specific surface area of the twisted carbon nanotube wire will decrease. The density and strength of the twisted carbon nanotube wire will be increased. It is understood that the twisted and untwisted carbon nanotube cables can be produced by methods that are similar to the methods of making twisted and untwisted carbon nanotube wires.

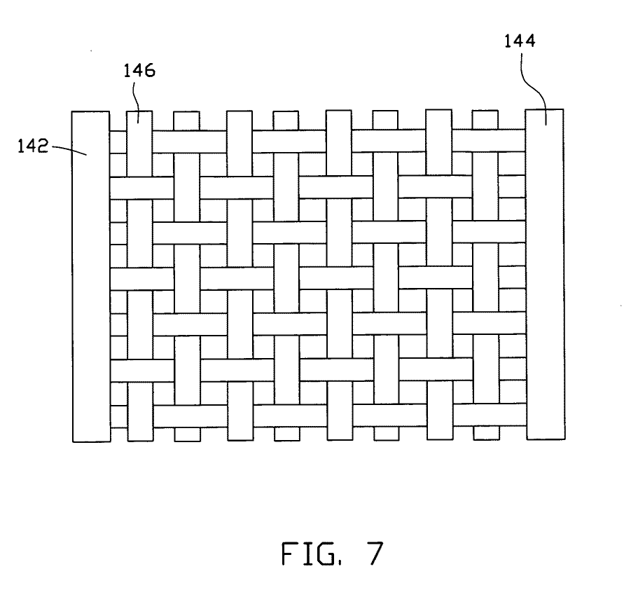

The carbon nanotube structure can include a plurality of carbon nanotube wire structures. The plurality of carbon nanotube wire structures can be paralleled with each other, cross with each other, weaved together, or twisted with each other. The resulting structure can be a planar structure if so desired. Referring to FIG. 7, a carbon nanotube textile can be formed by the carbon nanotube wire structures 146 and used as the carbon nanotube structure. The first electrode 142 and the second electrode 144 can be located at two opposite ends of the textile and electrically connected to the carbon nanotube wire structures 146. It is also understood that the carbon nanotube textile can also be formed by treated and/or untreated carbon nanotube films.

The carbon nanotube structure has a unique property which is that it is flexible. The carbon nanotube structure can be tailored or folded into many shapes and put onto a variety of rigid or flexible insulating surfaces, such as on a flag or on clothes. The flag having the carbon nanotube structure can act as the sound wave generator 14 as it flaps in the wind. The sound produced is not affected by the motion of the flag. Additionally, the ability of the flag to move is not substantially affected given the lightweight and the flexibility of the carbon nanotube structure. Clothes having the carbon nanotube structure can attach to a MP3 player and play music. Additionally, such clothes could be used to help the handicap, such as the hearing impaired.

The first electrode 142 and the second electrode 144 can be on the same surface of the sound wave generator 14 or on two different surfaces of the sound wave generator 14. The first electrode 142 and the second electrode 144 are made of conductive material. The shape of the first electrode 142 or the second electrode 144 is not limited and can be lamellar, rod, wire, and block, among other shapes. A material of the first electrode 142 or the second electrode 144 can be metals, conductive adhesives, carbon nanotubes, and indium tin oxides, among other materials. In one embodiment, the first electrode 142 and the second electrode 144 are rod-shaped metal electrodes. The sound wave generator 14 is electrically connected to the first electrode 142 and the second electrode 144. The electrodes can provide structural support for the sound wave generator 14. Some sound wave generators 14 can be adhered directly to the first electrode 142 and the second electrode 144 and/or many other surfaces because some of the carbon nanotube structures have large specific surface area. This will result in good electrical contact between the sound wave generator 14 and the electrodes 142, 144. The first electrode 142 and the second electrode 144 can be electrically connected to two ends of the signal device 12 by a conductive wire 149.

In other embodiment, a conductive adhesive layer (not shown) can be further provided between the first electrode 142 or the second electrode 144 and the sound wave generator 14. The conductive adhesive layer can be applied to the surface of the sound wave generator 14. The conductive adhesive layer can be used to provide electrical contact and greater adhesion between the electrodes 142, 144 and the sound wave generator 14. In one embodiment, the conductive adhesive layer is a layer of silver paste.

In other embodiment, the flexible thermoacoustic device 10 can further include more than two electrodes. The electrodes can be connected on any surface of the carbon nanotube structure. It is understood that more than two electrodes can be on one or more surfaces of the sound wave generator 14, and be connected in the manner described above.

The flexible thermoacoustic device 10 can further include a signal device 12. The signal device 12 can be connected to the sound wave generator 14 directly via a conductive wire or indirectly. The signal device 12 can include electrical signal devices, pulsating direct current signal devices, alternating current devices and/or electromagnetic wave signal devices (e.g., optical signal devices, lasers). The signals output from the signal device 12 can be, for example, electromagnetic waves (e.g., optical signals), electrical signals (e.g., alternating electrical current, pulsating direct current signals, signal devices and/or audio electrical signals), or a combination thereof. Energy of the signals is absorbed by the carbon nanotube structure and then radiated as heat. This heat causes detectable sound signals due to pressure variation in the surrounding (environmental) medium. It can be understood that the signals are different according to the specific application of the thermoacoustic device 10. For example, when the thermoacoustic device 10 is applied to an earphone, the input signals can be AC electrical signals or audio signals. When the thermoacoustic device 10 is applied to a photoacoustic spectrum device, the input signals are optical signals. In the embodiment of FIG. 1, the signal device 12 is an electric signal device, and the input signals are electric signals.

The carbon nanotube structure comprises a plurality of carbon nanotubes and has a small heat capacity per unit area. The carbon nanotube structure can have a large area for causing the pressure oscillation in the surrounding medium by the temperature waves generated by the sound wave generator 14. In use, when signals, e.g., electrical signals, with variations in the application of the signal and/or strength are applied to the carbon nanotube structure of the sound wave generator 14, heating is produced in the carbon nanotube structure according to the variations of the signal and/or signal strength. Temperature waves, which are propagated into the surrounding medium are obtained. The temperature waves produce pressure waves in the surrounding medium, resulting in sound generation. In this process, it is the thermal expansion and contraction of the medium in the vicinity of the sound wave generator 14 that produces sound. This is distinct from the mechanism of the conventional loudspeaker, in which the pressure waves are created by the mechanical movement of the diaphragm. When the input signals are electrical signals, the operating principle of the thermoacoustic device 10 is an “electrical-thermal-sound” conversion. When the input signals are optical signals, the operation principle of the thermoacoustic device 10 is an “optical-thermal-sound” conversion. Energy of the optical signals can be absorbed by the sound wave generator 14 and the resulting energy will then be radiated as heat. This heat causes detectable sound signals due to pressure variation in the surrounding (environmental) medium.

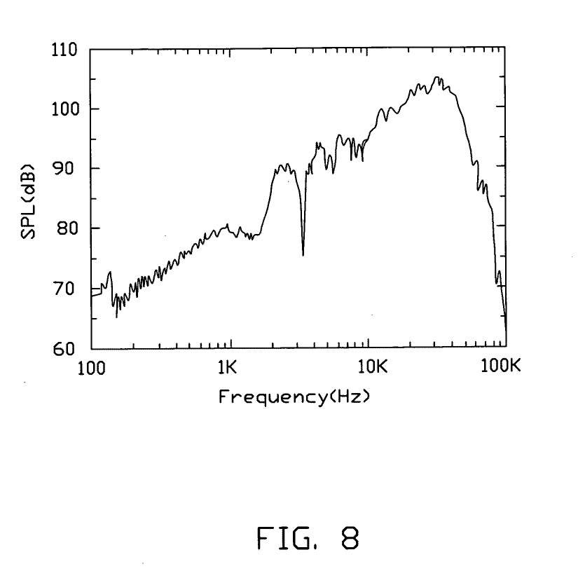

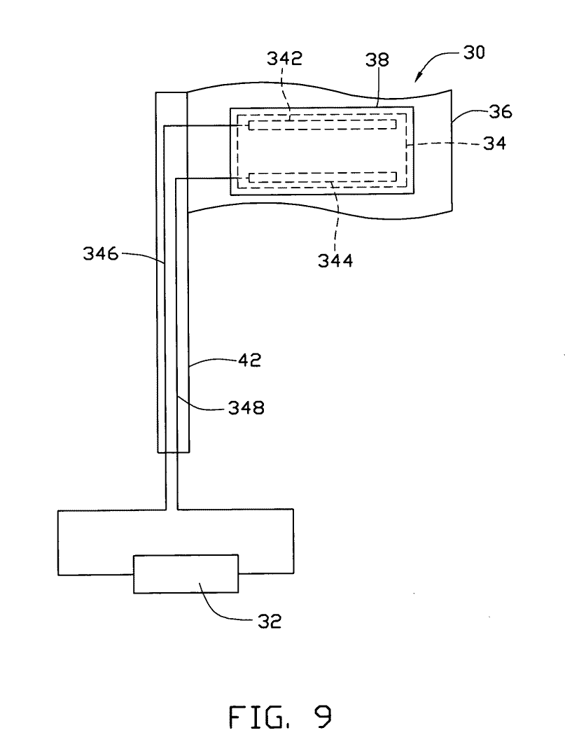

FIG. 8 shows a frequency response curve of the thermoacoustic device 10 according to the embodiment described in FIG. 1. To obtain these results, an alternating electrical signal with 50 volts is applied to the carbon nanotube structure. A microphone put in front of the sound wave generator 14 with a distance of about 5 centimeters away from the sound wave generator 14 is used to measure the performance of the thermoacoustic device 10. As shown in FIG. 9, the thermoacoustic device 10, of the embodiment shown in FIG. 1, has a wide frequency response range and a high sound pressure level. The sound pressure level of the sound waves generated by the thermoacoustic device 10 can be greater than 50 dB. The sound pressure level generated by the thermoacoustic device 10 reaches up to 105 dB. The frequency response range of the thermoacoustic device 10 can be from about 1 Hz to about 100 KHz with power input of 4.5 W. The total harmonic distortion of the thermoacoustic device 10 is extremely small, e.g., less than 3% in a range from about 500 Hz to 40 KHz.

Referring to FIG. 9, a thermoacoustic flag 40 according to another embodiment includes a banner 30 attached to a mast 42.

The banner 30 is a flexible thermoacoustic device having the same structure as the thermoacoustic device 10 disclosed in the embodiment of FIG. 1. The banner 30 includes a soft supporter 36, a sound wave generator 34, a first electrode 342, and a second electrode 344. The banner 30 further includes a protecting layer 38. The protecting layer 38 is located on a surface of the sound wave generator 34, so that the sound wave generator 34 is disposed between the soft supporter 36 and the protecting layer 38. The material of the soft supporter 36 and the protecting layer 38 can be cloth, fiber, wool, and any other flexible and insulative material.

The sound wave generator 34 includes a carbon nanotube structure. All embodiments of the carbon nanotube structure discussed above can be incorporated into the sound wave generator 34. In the present embodiment, the carbon nanotube structure includes a plurality of carbon nanotubes arranged substantially in a same direction.

The material of the mast 42 can be metal, plastic, and wood. The shape of the mast 42 is not limited. In one embodiment, the mast 42 is a hollow pole.

In one embodiment, the first electrode 342 and the second electrode 344 are substantially parallel with each other. The carbon nanotubes in the carbon nanotube structure are substantially perpendicular to the first electrode 342 and the second electrode 344. The first electrode 342 and the second electrode 344 are bar-shaped and made of platinum (Pt). A thickness of the first electrode 342 and the second electrode 344 is in a range from about 0.1 μm to about 10 μm. All embodiments of the electrodes discussed above can be incorporated into the first electrode 342 and the second electrode 344.

The thermoacoustic flag 30 can further include a signal device 32 having the same structure as the signal device 12. The signal device 32 can be electrically connected to the sound wave generator 34 via a first conductive wire 346 and a second conductive wire 348. The first conductive wire 346 is electrically connected to the first electrode 342 and the second conductive wire 348 is electrically connected to the second electrode 344. In one embodiment, the mast 42 is a hollow pole, and the first conductive wire 346 and the second conductive wire 348 are both disposed in the hollow pole. One terminal of the first conductive wire 346 is electrically connected to the first electrode 342, and the other terminal of the first conductive wire 346 extends out of the mast 42. One terminal of the second conductive wire 348 is electrically connected to the second electrode 344, and the other terminal of the second conductive wire 348 extends out of the mast 42. The terminals of the first conductive wire 346 and the second conductive wire 348 extending out of the mast 42 are configured to facilitate electrical connection with the signal device 32.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate rather than limit the scope of the present disclosure.

What is claimed is:

1. A flexible thermoacoustic device, comprising a soft supporter and
a sound wave generator located on a surface of the soft supporter, the sound wave generator comprising a carbon nanotube structure comprising a plurality of carbon nanotubes combined by van der Waals attractive force.

2. The flexible thermoacoustic device of claim 1, wherein the heat capacity per unit area of the carbon nanotube structure is less than or equal to 1.7×10⁻⁶ J/cm²·K.

3. The flexible thermoacoustic device of claim 1, wherein the material of the soft supporter is selected from the group consisting of plastic, resin or fabric, paper, and rubber.

4. The flexible thermoacoustic device of claim 1, wherein the carbon nanotube structure is a substantially planar structure, and a thickness of the carbon nanotube structure ranges from about 0.5 nanometers to about 1 millimeter.

5. The flexible thermoacoustic device of claim 1, wherein the carbon nanotubes of the carbon nanotube structure are disorderly arranged.

6. The flexible thermoacoustic device of claim 5, wherein the carbon nanotubes of the carbon nanotube structure are entangled with each other.

7. The flexible thermoacoustic device of claim 1, wherein the carbon nanotubes of the carbon nanotube structure are orderly arranged.

8. The flexible thermoacoustic device of claim 7, wherein the carbon nanotubes of the carbon nanotube structure are joined end-to-end.

9. The flexible thermoacoustic device of claim 1, further comprising at least two electrodes, the at least two electrodes are electrically connected to the carbon nanotube structure and are spaced apart from each other.

10. The flexible thermoacoustic device of claim 9, wherein the at least two electrodes are attached on a surface of the carbon nanotube structure and substantially parallel to each other.

11. The flexible thermoacoustic device of claim 10, wherein the carbon nanotubes in the carbon nanotube structure are substantially perpendicular to the at least two electrodes.

12. The flexible thermoacoustic device of claim 9, further comprising a signal device electrically connected to the sound wave generator.

13. The apparatus of claim 12, wherein the flexible thermoacoustic device comprises a plurality of electrodes, and any two adjacent electrodes are electrically connected to different terminals of the signal device.

14. The apparatus of claim 9, wherein the at least two electrodes is made of material selected from the group consisting of metals, conductive adhesives, carbon nanotubes, and indium tin oxides.

15. The apparatus of claim 1, wherein the frequency response range of the sound wave generator ranges from about 1 Hz to about 100 KHz.

16. A flag, comprising a mast and a banner being attached to the mast,
the banner comprising a flexible thermoacoustic device comprising a sound wave generator comprising a carbon nanotube structure comprising a plurality of carbon nanotubes.

17. The flag of claim 16, wherein the banner further comprises a soft supporter and a protecting layer, and the sound wave generator is disposed between the soft supporter and the protecting layer.

18. The flag of claim 17, wherein the soft supporter or the protecting layer is made of a material selected from the group consisting of cloth, fiber, and wool.

19. The flag of claim 16, wherein the carbon nanotubes of the carbon nanotube structure are combined by van der Waals attractive force.

20. A flag, comprising a mast and a banner attached to the mast, the banner comprising a flexible thermoacoustic device comprising:
a soft supporter made of soft material;
a sound wave generator located on a surface of the soft supporter, the sound wave generator comprising a carbon nanotube structure comprising a plurality of carbon nanotubes combined by van der Waals attractive force;
at least two electrodes disposed on a surface of the sound wave generator and electrically connected to the sound wave generator; and
a protecting layer covering the sound wave generator and the at least two electrodes.
